(19) United States
(12) Patent Application Publication
(10) Pub. No.: US 2022/0276074 A1
(43) Pub. Date: Sep. 1, 2022

(54) SYSTEMS AND METHODS FOR THROUGH WALL LOCATING

(71) Applicant: Eric Haseltine, Rancho Palos Verdes, CA (US)

(72) Inventor: Eric Haseltine, Rancho Palos Verdes, CA (US)

(21) Appl. No.: 17/746,399

(22) Filed: May 17, 2022

Related U.S. Application Data
(63) Continuation-in-part of application No. 17/371,644, filed on Jul. 9, 2021.
Application No. 17/371,644 is a continuation of application No. 17/156,096, filed on Jan. 22, 2021, now Pat. No. 11,092,462.
(60) Provisional application No. 63/189,490, filed on May 17, 2021.

(51) Int. Cl. G01D 5/20

(52) U.S. Cl. CPC G01D 5/20

(57) ABSTRACT

A transmitter unit is provided for transmitting a continuous waveform in a magnetic field, the continuous waveform being an unmodulated electromagnetic waveform. The transmitter unit typically comprises a transmitting solenoid for transmitting the continuous waveform, and an oscillator for generating the continuous waveform. A receiver unit is also provided, the receiver unit having receiving circuitry, such as a receiving solenoid, for receiving the continuous waveform. The receiver unit also provides an output for outputting an indication of proximity between the transmitter unit and the receiver unit, where a characteristic of the indication of proximity depends on the strength of the magnetic field generated by the transmitter unit at the location of the receiving solenoid. Also provided is a method for using a system having a transmitter unit and a receiver unit.

### CROSS-REFERENCE TO RELATED APPLICATION

This application is a continuation in part of U.S. patent application Ser. No. 17/371,644, filed Jul. 9, 2021, which is a continuation of U.S. patent application Ser. No. 17/156,096, filed Jan. 22, 2021, the contents of which are incorporated by reference herein in their entirety. This application also takes priority from U.S. Provisional Patent Application No. 63/189,490, filed May 17, 2021, the contents of which are also incorporated by reference herein in their entirety.

### FIELD OF THE INVENTION

Systems and methods are described for precisely locating a position through a wall.

### BACKGROUND

Serious accidents may occur when construction or repair workers cutting or drilling through walls, including metal walls, fail to properly locate a target cutting location. Such workers may penetrate into hazardous areas such as fuel tanks, fuel lines, or electrical lines located on an opposite side of a wall they are cutting or drilling.

Such accidents are a common source of fires, for instance, in the ship repair and building industry where cutting torches applied from one side of a metal partition may inadvertently cut into hazardous areas on the opposite unseen side of the partition (such as a marine bulkhead). Systems and methods for precisely locating a safe place to cut so that damage is avoided on the opposite side of a partition have not previously been adequately developed due to problems with existing locating technologies.

Currently, workers often attempt to make precise measurements on both sides of the construction wall so that corresponding points on opposite sides of the wall are accurately located independently. Another common approach is to “tap” or use other acoustic energy (i.e., tones) and to have workers attempt to locate the source of the energy on the opposite side of the wall. These attempts are typically imprecise and unreliable.

Such problems are exacerbated when dealing with metal partitions or walls, and include difficulty with locating sounds or other types of energy through thick metal, such as structural plate steel. For instance, plate steel used in marine bulkheads dissipates acoustic energy from sharp taps or other sources so that precise location of corresponding points on opposite sides of walls are difficult.

In addition to the difficulty in locating hazards on opposite sides of walls, similar challenges exist in defining highly precise fiducial points from which to make measurements. Such marking is often impractical in many construction and repair settings.

Other existing approaches are to use permanent magnets to mark a location on one side of a wall, such that a magnetometer placed on the opposite side of the wall can detect the magnet's location. However, the high magnetic permeability of ferrous substances, such as structural steel, also tends to absorb, or shunt, magnetic fields, thereby attenuating and diffusing magnetic fields. This makes precise location difficult, even when using strong permanent magnets.

Additionally, because partitions may reduce the effectiveness of various forms of communication, such as acoustic communications (i.e., talking through the wall) or radio frequency (RF) based communications, it is difficult for workers on opposite sides of a partition to communicate with each other.

There is a need for systems and methods for the precise location of hazards on one side of a wall to be clearly revealed on the other side of that wall, so that workers can safely penetrate the wall surface. There is a further need for systems and methods for precisely locating fiducial points that can be used as references. There is a further need for systems and methods by which workers can communicate through a wall.

### SUMMARY

The current disclosure provides systems and methods for overcoming limitations of previous approaches by employing a transmit/receiver pair that radiate and receive a series of strong, time varying electromagnetic pulses that can be used to precisely locate corresponding points on opposite sides of a wall.

Electromagnetic pulses produced on one side of a wall, emanating from a transmit coil create a sharp magnetic field gradient, resulting in a steeply sloping magnetic field, on the opposite side of the wall. A receiver with a sensitive pick-up coil can then discriminate small differences in magnetic field strength in order to locate the spot of peak magnetic strength indicating the position nearest the transmit coil on the opposite side of a wall.

The use of time varying magnetic pulses allows for optimizing a frequency of oscillations to maximize electromagnetic transmission through a metal wall. The pulses may be shaped and adjusted to further make those pulses easily audible to the human ear, once amplified. Such an approach allows for precise localization on opposite sides of a wall. Some embodiments may thereby produce localizations within an accuracy of 1-3 mm.

In some embodiments, the transmitter and receiver each include solenoid coils, and when a location is properly located, both solenoids are aligned with each other axially. In such an embodiment, slight variations in the position of the receiver coil with respect to the transmitter coil would produce large variations in signal strength, thereby achieving better accuracy.

In some embodiments, a transmitter unit is provided for transmitting a magnetic or electromagnetic signal that may be a continuous waveform in a magnetic field, the continuous waveform being an unmodulated electromagnetic waveform. The transmitter unit typically comprises a transmitting solenoid for transmitting the continuous waveform, and an oscillator for generating the continuous waveform.

A receiver unit is also provided, the receiver unit having receiving circuitry, such as a receiving solenoid, for receiving the continuous waveform. The receiver unit also provides an output for outputting an indication of proximity between the transmitter unit and the receiver unit, where a characteristic of the indication of proximity depends on the strength of the magnetic field generated by the transmitter unit at the location of the receiving solenoid.

The receiver unit may further comprise an amplifier for amplifying the continuous waveform received at the receiving solenoid in proportion with an intensity of the waveform received at the receiving solenoid.

Typically, the transmitting and receiving solenoids are oriented perpendicular to a wall through which a location is being located during use. The receiving solenoid may be selected to be in resonance with the transmitting solenoid at a frequency of the continuous waveform.

In some embodiments, both the transmitting and receiving solenoids are selected, along with corresponding capacitors, to be in resonance at the frequency of the continuous waveform, thereby increasing the strength of the magnetic field at the location of the receiving solenoid by way of resonant inductive coupling when the solenoids are substantially axially aligned.

In some embodiments, the continuous waveform is an ultra-low frequency or lower frequency waveform. In some embodiments, the waveform may be below 10 Hz, or at approximately 5 Hz. In some embodiments, the waveform is a square waveform.

In some embodiments, the output is an audio amplifier for amplifying the continuous waveform proportionally to the magnetic field strength at the receiving circuitry, such as the receiving solenoid, and outputting the amplified continuous waveform as audio. The characteristic of the indication of the proximity that at least partially depends on magnetic field strength may then be volume, frequency, sharpness, or pitch of the audio output. In some such embodiments, the continuous waveform may be a square waveform, and the volume and sharpness of the audio output may then vary based on location of the receiving circuitry.

In some embodiments, the transmitter unit may further comprise a permanent magnet for fixing the transmitter unit to a wall through which the system is being used to locate.

In some embodiments, a core of at least one of the transmitting solenoid and receiving solenoid is tapered at an end of the corresponding solenoid adjacent the wall. In some embodiments, the tapered end is further provided with a collar formed of a ferrous material.

In some embodiments, instead of a transmitting solenoid, a permanent magnet is provided. In other embodiments, the transmitting solenoid is provided with a DC signal, thereby simulating a permanent magnet.

In some embodiments, a permanent magnet is combined with the transmitting solenoid, such that the magnetic field at the receiving solenoid is a combination of AC and Dc properties.

Also provided is a method for through wall locating. Such a method may comprise locating a transmitter unit adjacent a desired location on a first side of a wall, and transmitting a continuous electromagnetic waveform from the transmitter unit.

A user then locates a receiver unit adjacent the wall opposite the transmitter unit, where the receiver unit includes receiving circuitry and an output for outputting an indication of proximity.

The receiving circuitry then receives the continuous electromagnetic waveform output by the transmitter unit and generates an indication of proximity based at least partially on the strength of the magnetic field generated by the transmitter unit at the receiving circuitry.

The receiver unit continuously outputs the indication of proximity at the output while a user moves the receiver unit along the wall.

Also provided is a method for through-wall communications. Such a method comprises positioning a transmitter unit for transmitting communications adjacent a desired location on a first side of a wall and positioning a receiver unit for receiving communications through the wall adjacent the wall and on an opposite side of the wall from the transmitter unit. The receiver unit comprises receiving circuitry and an output for outputting a communication received from the transmitter unit.

The method then proceeds with transmitting an electromagnetic waveform from the transmitter unit and receiving, at the receiving circuitry of the receiver unit, the electromagnetic waveform output by the transmitter unit.

The method then includes generating, at the receiving circuitry of the receiver unit, a message based on the electromagnetic waveform received and outputting the message at the output of the receiver unit.

In some such embodiments, the transmitter unit comprises transmission circuitry for receiving a message for transmission, and the received message is then encoded into the electromagnetic waveform prior to output. The encoding may be by modulating a continuous waveform or pulsing a discontinuous waveform.

The message may be text based prior to encoding and after extracting the message from the waveform.

The electromagnetic waveform may have a frequency lower than 10 Hz.

### BRIEF DESCRIPTION OF THE DRAWINGS

FIG. 1 shows an embodiment of a system in accordance with this disclosure.

FIG. 2 shows flux coupling between adjacent solenoid coils with flux being transferred from an active solenoid to a passive solenoid.

FIG. 3A shows the coupling of transmitting and receiving solenoid coils in the context of the system.

FIG. 3B shows the coupling of FIG. 3A with an intervening wall attenuating flux through the wall.

FIG. 4A shows the resulting magnetic flux in solenoid coils having different diameters.

FIG. 4B shows the resulting magnetic flux in coupled solenoid coils when the coils are axially aligned.

FIG. 4C shows the resulting magnetic flux in coupled solenoid coils when those coils are spaced apart.

FIG. 5A shows the response to a square pulse at a receiving coil when transmission and receiving coils are misaligned.

FIG. 5B shows the response to a square pulse at a receiving coil when transmission and receiving coils are aligned.

FIG. 6 is a flowchart illustrating a method in accordance with this disclosure.

FIG. 7 shows a second embodiment of a system in accordance with this disclosure.

FIG. 8A shows an additional embodiment of a coupling of a transmitter unit and a receiver unit with an intervening wall attenuating flux.

FIG. 8B is a profile of magnetic field strength in a lateral direction away from the axis of the transmitter unit of FIG. 8A.

FIG. 9A shows an additional embodiment of a coupling of a transmitter unit and a receiver unit with an intervening wall attenuating flux.

FIG. 9B is a profile of magnetic field strength in a lateral direction away from the axis of the transmitter unit of FIG. 9A.

FIG. 10 is a comparison of slope of fall-off of magnetic field strength with different lateral displacements being both tapered and untapered.

FIG. 11A shows an additional embodiment of a coupling of a transmitter unit and a receiver unit with an intervening wall attenuating flux.

FIG. 11B is a profile of magnetic field strength in a lateral direction away from the axis of the transmitter unit of FIG. 11A.

FIG. 12A is an oscilloscope trace of voltages sensed in a receive solenoid moved laterally along a steel surface with a permanent magnet placed opposite a steel plate.

FIG. 12B is an oscilloscope trace of voltages sensed in a receive solenoid moved laterally along a steel surface with a permanent magnet paired with a transmit solenoid placed opposite a steel plate.

FIG. 13 shows an additional embodiment of a system in accordance with this disclosure.

FIG. 14 shows a response to a transmission in the context of the system of FIG. 13.

FIG. 15 illustrates a method for utilizing the system of FIG. 13.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

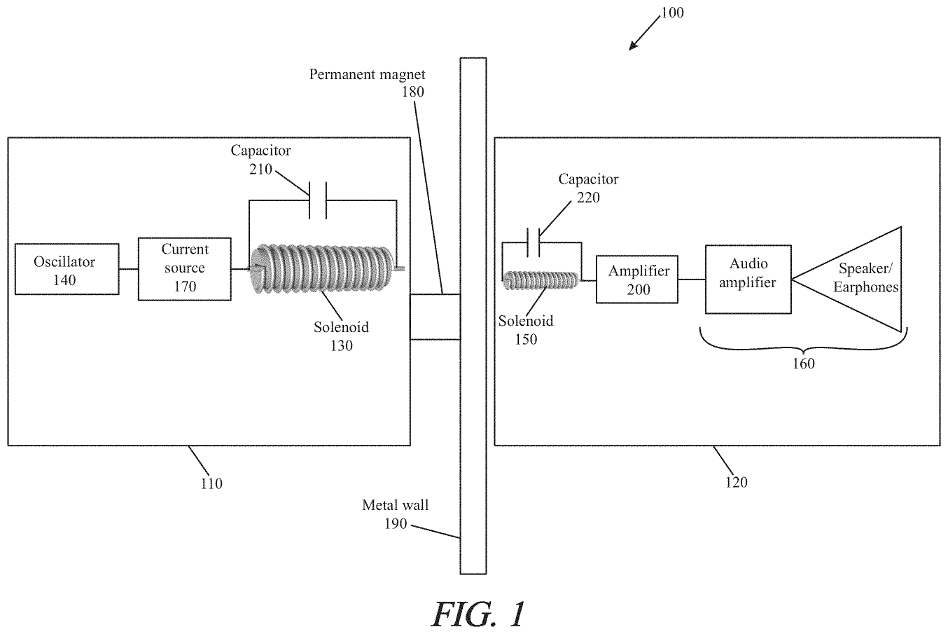

FIG. 1 shows an embodiment of a system 100 in accordance with this disclosure. As shown, the system 100 includes a transmitter unit 110 and a receiver unit 120.

The transmitter unit 110 typically transmits a continuous waveform as a magnetic field. The waveform may be transmitted by a transmitting solenoid 130 contained within the transmitter unit 110. The transmitter unit 110 may further comprise a harmonic oscillator 140 for generating the continuous waveform to be transmitted and providing it to the transmitting solenoid 130 for transmission.

The receiver unit 120 may then comprise receiving circuitry, typically including a receiving solenoid 150, which receives the continuous waveform transmitted by the transmitter unit 110. The receiving solenoid 150 receives the continuous waveform through induction and generates a voltage from the magnetic field radiated by the transmitting solenoid 130.

The receiver unit 120 may further comprise an output 160 for outputting an indication of a proximity between the transmitter unit 110 and the receiver unit 120. The indication of proximity may include a characteristic depending on the strength of the magnetic field generated by the transmitter unit 110 at the location of the receiving solenoid 150.

The transmitter unit 110 may include a current source 170 or amplifier paired with the oscillator 140 in order to drive the transmitting solenoid 130 and output the continuous waveform. The current source 170 or amplifier would then amplify voltage and current supplied to the transmitting solenoid 130, such that the solenoid radiates an alternating current (AC) magnetic field. The continuous waveform is typically a periodic unmodulated electromagnetic waveform, such that the continuous waveform does not act as a carrier signal for carrying data. The waveform may be a square wave, and may be an ultra-low frequency or lower frequency waveform as discussed in more detail below. For example, the waveform may be a square waveform having a frequency of 5 Hz.

The transmitter unit 110 may further include a permanent magnet 180, which may be used to locate the transmitter unit adjacent a desired location on a first side of a wall 190.

The receiver unit 120 may include an amplifier 200, which may be a pre-amp, for amplifying the continuous waveform received from the transmitting solenoid 130 by way of the receiving solenoid 150. The amplifier 200 then amplifies the continuous waveform in proportion with an intensity of the waveform received at the receiving solenoid 150. The intensity of the waveform is a function of the strength of the magnetic field generated by the transmitter unit 110 at the location of the receiving solenoid 150.

As shown in FIG. 1, when in use, the transmitter unit 110 is located adjacent a desired location on a wall 190, where it may be fixed using a permanent magnet 180. For example, the wall may be structural steel or plate steel, or some other ferrous material, such that the permanent magnet may be used to fix the transmitter unit 110 for use in measurement. Typically, the desired location is either a specific location which the user would like to use as a fiducial point, such that an identical point opposite the wall should be identified, or the desired location is simply a location that is safe to cut or drill from the opposite side.

The receiver unit 120 may then be brought close to the wall 190 from the opposite side while the transmitter unit 110 is fixed by way of the permanent magnet 180, such that the continuous waveform output by the transmitting solenoid 130 of the transmitter unit is received at the receiving solenoid 150 of the receiver unit 120.

As discussed in more detail below, when the transmitter unit 110 and the receiver unit 120 are brought closer to each other through the wall 190 and are brought more closely into alignment, the magnetic field generated by the transmitter unit 110 at the location of the receiving circuitry 150 is increased. This is then reflected in the indication of proximity as a characteristic of that indication.

The amplifier 200 receives the continuous waveform from the receiving solenoid 150 as a voltage generated from the magnetic field and amplifies it in proportion with an intensity of the waveform received at the receiving solenoid. In some embodiments, the output 160 includes an audio amplifier which further amplifies the continuous waveform proportionally to the magnetic field strength at the receiving circuitry 150 and outputs the amplified continuous waveform as audio by way of speakers or earphones, where the characteristic of the indication of the proximity is volume, frequency, sharpness, or pitch of the audio output.

Accordingly, in the example of the square waveform above having a nominal frequency of 5 Hz, the square waveform would be received at the receiving solenoid 150, amplified by the amplifier 200 and then fed into an audio amplifier 160. The square waveform would then be output as audio proportional to the magnetic field strength associated with the square waveform at the receiving solenoid 150. As such, when output through a speaker or headphones, the user would hear a 5 Hz beating sound, similar to the thump of helicopter rotors.

Because the magnetic field strength would change when the receiver unit 120 is moved, the changing field strength would increase and decrease in intensity as the user moves the receiver unit 120 closer to or farther away from the point at which the transmitter unit 110 is located on the opposite side of the wall 190. Accordingly, when the user moves the receiver unit 120 closer to the transmitter unit 110, the volume of the audio at the output 160 increases. The periodic nature of the waveform translated to audio makes it much easier for the human ear to detect than a static, field intensity related signal, such as that which would be generated by a permanent magnet.

When in use, the transmitting solenoid 130 and the receiving solenoid 150 are both typically oriented perpendicular to the wall 190 through which the location is being located. This allows for the receiving solenoid 150 to resonate effectively with the transmitting solenoid 130. The transmitting solenoid 130 is typically located within the transmitter unit 120 such that it comes as close as possible to abutting the wall 190. Similarly, the receiver unit 120 is typically packaged such that when in use, the receiving solenoid 150 may be placed as close as possible to abutting the wall 190 from the opposite side.

In the embodiment, shown, the transmitting solenoid 130 and the receiving solenoid 150 may be selected so as to enhance the transmission of the continuous waveform when the solenoids are close to each other and in alignment and to increase the sharpness of their drop off when taken out of alignment. Accordingly, the transmitting solenoid 130 and receiving solenoid 150 are each paired with resonant capacitors 210, 220 to form LC circuits. In order to bring the coil into resonance at the frequency of the desired continuous waveform, the values for the solenoid transmitter 130 inductance L and the capacitance of the corresponding capacitor 210 are selected to approximate the results of the resonance formula:

$${f}_{r} = \frac{1}{2 π \sqrt{LC}} Hz$$

Where fᵣ is the frequency at which resonance is sought, in this case 5 Hz. The receiving solenoid 150 and capacitor 220 are similarly selected to be in resonance at the desired frequency. By selecting both LC circuits to be in resonance, during use, the strength of the magnetic field generated by the transmitter unit at the location of the receiving circuitry may then be increased by resonance inductive coupling when the transmitting solenoid 130 and the receiving solenoid 150 are substantially axially aligned.

The transmitter solenoid 130 typically has a solid core which may be formed from a high permeability mu metal. In such embodiments, the metal core may have mu>50,000 at 5 HZ, thereby increasing its inductance.

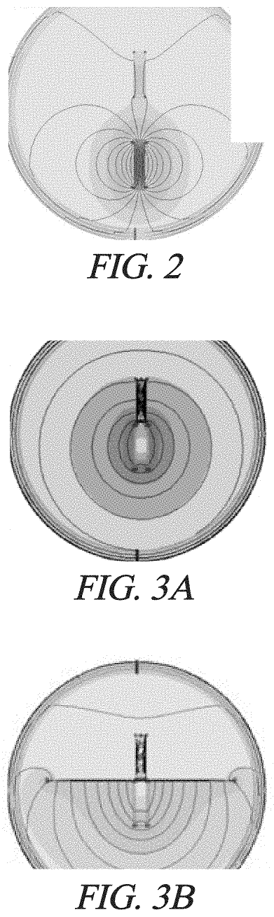

FIG. 2 shows flux coupling between adjacent solenoid coils 230, 250 with flux being transferred from an active solenoid to a passive solenoid. As shown, even where the transmitter solenoid 230 is active and the receiving solenoid 250 is a passive metal core solenoid, the magnetic fields of the solenoids will couple. In the example shown, the flux density is shown using grayscale, and an increase in flux density in the metal core of the receiving solenoid 150 is generated by the magnetic field of the active transmitter solenoid 130 so long as the solenoids are in or near alignment. This increased flux, visible even in a passive receiving solenoid 150, relative to the surrounding medium (having a permeability of 1 in the image shown), supports transfer of the continuous waveform from the transmitter solenoid 130 to the receiving solenoid 150.

FIG. 3A shows the coupling of transmitting 130 and receiving 150 solenoid coils in the context of the system 100. FIG. 3B shows the coupling of FIG. 3A with an intervening wall 190 attenuating flux through the wall. As shown, the flux coupling effect, which was visible in the context of the passive receiving solenoid of FIG. 2, is more dramatic in the context of an active receiving solenoid 150.

This flux coupling by way of the magnetic field generated by the transmitter unit 110 allows for the transmission of the continuous waveform as discussed above. As shown in FIG. 3A, when coupled without any intervening wall, the transmitting solenoid 130 and the receiving solenoid 150 fully couple to form a single magnetic field.

As shown in FIG. 3B, when a ferrous metal wall 190 is present, that wall acts as a magnetic shield, concentrating magnet lines of flux within it. This effect reduces the magnetic field detectable on the opposite side of the wall 190. In the configuration discussed above in reference to FIG. 1, the transmitting solenoid 130 acts like a primary winding of a transformer while the receiving solenoid 150, in the receiver unit 120, acts as the secondary winding of the hypothetical transformer.

Because the ferrous metal wall 190 blocks or effectively shunts a significant portion of the magnetic field generated in the transmitting solenoid 130, only a small portion of the original transmitted magnetic field is available to generate a voltage in the receiving solenoid 150. The reduction in field strength, as well as resulting signal strength, due to the ferrous metal wall 190, makes it difficult for a receiver unit 120 to detect magnetic fields produced by the transmitter unit 110, unless the transmitting 130 and receiving 150 solenoids are axially aligned in order to support flux coupling. This results in a dramatic drop off in the strength of the magnetic field when the solenoids 130, 150 are taken out of alignment.

The use of flux coupling to increase the effective magnetic field at the receiver unit 120 results in a signal that is strongest when the transmitter unit 110 and receiver unit 120 are well aligned, and a rapid fall off of signal strength as the transmitting 130 and receiving 150 coils are moved out of alignment. This allows for precise localization of the receiver unit 120, as small displacements from perfect or near perfect alignment will produce very noticeable and dramatic differences in signal strength. In the system 100 of FIG. 1, this results in a quick drop off of the intensity of acoustic signals delivered to the ears of a human operator.

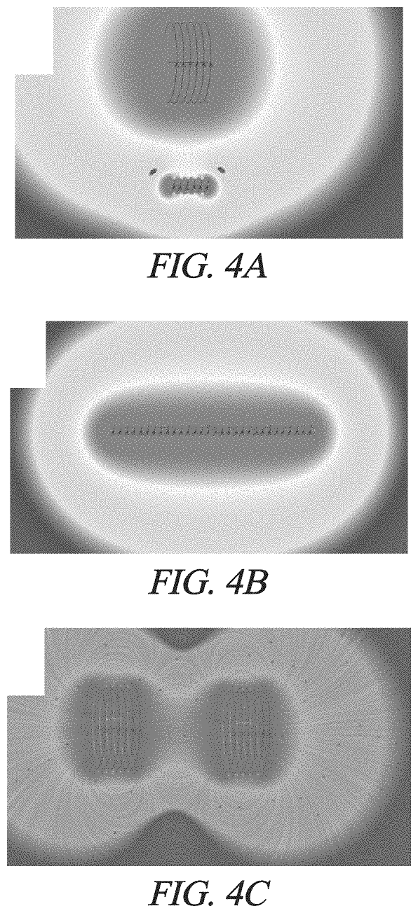

FIG. 4A shows the resulting magnetic flux in solenoid coils 400, 410 having different diameters. As shown, a magnetic field generated by a transmitting coil drops off as a distance from the coil increases. However, that drop off is faster when observed in a cross section perpendicular to an axis of the solenoid than in a cross section parallel to that axis. Accordingly, the gradient shown is much more spread out when viewed axially than when viewed perpendicularly. This results in a relatively sharp magnetic field extending from the lateral ends of the solenoids. The sharpened nature of this field means that the magnetic field will drop off quickly when a receiver unit is not properly aligned with a transmitter unit.

Further, as shown in FIG. 4A, the axially extending magnetic field is sharper when the solenoid 410 has a smaller diameter. This increased fall off of field strength results in increased sensitivity as the diameter of the solenoid decreases. As such, the solenoids used in the transmitter and receiver discussed above may be provided with small diameters.

FIG. 4B shows the resulting magnetic flux in coupled solenoid coils 400, 410 when the coils are axially aligned. As shown, the increased axial length of the solenoid results in a further sharpened magnetic field at the ends of the coupled solenoids.

FIG. 4C shows the resulting magnetic flux in coupled solenoid coils 420, 430 when those coils are spaced apart. As shown, the increased flux in the receiving coil 430 that results from coupling is retained even when the coils are spaced apart. However, when the coils are moved out of alignment, the magnetic field at the receiving coil 430 is substantially reduced. Further, as shown in FIG. 4C, field strength is greater between the two solenoids 420, 430, due to the flux coupling discussed above, than at the lateral axial ends of the magnetic field. This field strength is at a maximum, regardless of the space between the solenoids 420, 430, when the solenoids are aligned.

As discussed above, in the example of a square wave output at 5 Hz, a user will hear a beating sound that increases and decreases in intensity when the user moves the receiver unit 120 closer to and farther away from the location of the transmitter unit 120 on the opposite side of the wall. When the peak sound is perceived, the user knows that the transmitting 110 and receiver unit 120 are precisely aligned, because inductive coupling of transmitting 130 and receiving solenoids 150 is at a maximum when the solenoids are aligned.

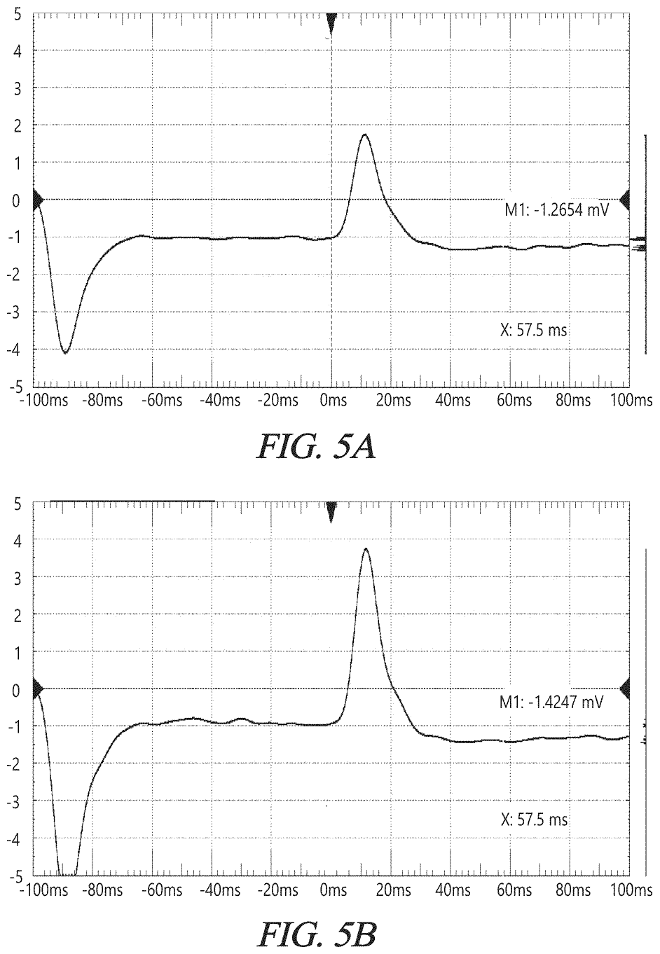

FIG. 5A shows the response to a square pulse at a receiving coil when transmission and receiving coils are misaligned by approximately two inches. FIG. 5B shows the response to a square pulse at a receiving coil when transmission and receiving coils are aligned. As shown, FIG. 5B, which shows the oscilloscope readout at a receiving coil, shows a response having a higher amplitude than the response shown for the misaligned configuration of FIG. 5A. Further, the slopes of the waveform received in FIG. 5B are steeper than for the misaligned configuration of FIG. 5A.

Accordingly, as shown, as the receiving coil is brought into alignment with the transmitting coil, the volume output at the audio amplifier 160 in the context of the system 100 discussed above is increased significantly. Further, in the case of the square pulse shown, the sound becomes sharper as the coils come into alignment. As such, when the solenoids are aligned, users hear loud, sharp, clicking noises. In contrast, when the solenoids are off axis, the pulse is softer, due to the shallower slope, and the click is also quieter.

It is further noted that magnetic field strength typically falls off at a rate of approximately the cube of the distance from the magnetic source. Therefore, small misalignments will, as shown, result in dramatic fall offs in magnetic field strength, which are then reflected in the output discussed.

Square waves provide a broad spectrum stimulus containing energy at the fundamental and all odd harmonics. This makes it effective for allowing the human ear, which is sensitive to spectral content, to discriminate different positions. Accordingly, clicks having broadband content in the form of a square wave convey more precise location information to the brain than do pure tones.

As such, by providing the continuous waveform in the system 100 in the form of a square pulse, the user can listen to the sound change both in terms of intensity and sharpness.

While the embodiment of FIG. 1 is discussed in the context of a 5 Hz square continuous waveform, additional waveforms are contemplated as well. It is noted the ideal frequency may vary across different materials. Accordingly, 5 Hz may be ideal for most hardened steel materials used in solid metal walls, such as in marine bulkheads. However, ferrous metals may exhibit different efficiencies as transformer cores at different frequencies, which is why allows chosen for transformer cores are selected to have peak response and minimum losses at specific frequencies.

Accordingly, in some embodiments, the frequency of the continuous waveform may be modified or selected on the basis of the particular material through which a point is being located. In such embodiments, the resonating capacitors 210, 220 paired with the solenoids 130, 150 may be adjustable, such that when the frequency is modified, the capacitance of the capacitors are similarly modified so as to maintain the LC circuit of the solenoid and capacitors in resonance at the newly selected frequency.

While the frequency of the continuous waveform may be modified to increase propagation through particular materials, it is further noted that low frequencies, generally in the ultra-low frequency or lower range, and typically below 10 Hz, are more easily heard and discernable as individual sounds by users. Accordingly, the 5 Hz waveform discussed would be heard by a user as a beating sound, while a higher frequency waveform may not be heard at all, or may be heard only as a hum. The lower frequency sound may make it easier to discern changes in characteristics of the sound, such as volume, frequency, sharpness, or pitch, thereby making it easier for a user to determine if they are approaching a local maximum during use of the system 100 described.

Further, while a square waveform has advantages, as discussed above, different waveform shapes are contemplated as well. For example, the waveform may be sawtooth, sinusoidal, or more complex.

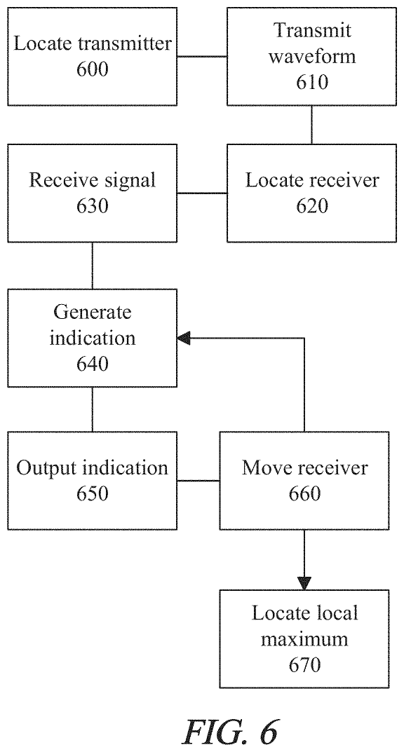

FIG. 6 is a flowchart illustrating a method for using the system 100 discussed above in accordance with this disclosure. The method may be used for identifying a particular location on a second side of a metal wall 190 corresponding to a desired location on a first side of the wall. The wall 190 may be, for example, a ferrous metal wall. This may be to identify a particular fiducial point for use as a reference, or it may be to identify a location on the wall that is safe for drilling or cutting.

A user of the system 100 initially locates (600) the transmitter unit 110 at a desired location on the first side of the wall 190. This may be by fixing the transmitted unit 110 to the wall by way of a permanent magnet 180 integrated into a housing of the transmitter unit 110.

The user then transmits (610) a magnetic field, such as a continuous electromagnetic waveform from the transmitter unit 110. As discussed above, the continuous electromagnetic waveform may be a square wave transmitted at approximately 5 Hz, and may be transmitted by way of a transmitting solenoid 130 located directly adjacent the wall 190 when the transmitter unit 110 is fixed thereto. Alternatively, as discussed in more detail below, the magnetic field may be a DC transmission, such as by a permanent magnet or a simulated permanent magnet. Similarly, the magnetic field may be a combination of AC and DC components.

While the continuous electromagnetic waveform or other magnetic field is being transmitted by the transmitter unit 110, thereby generating a magnetic field, the user locates (620) the receiver unit 120 adjacent the wall 190 opposite the transmitter unit 110. This initial locating is typically a guess made by the user as to the approximate location of the transmitter unit 110 opposite the wall 190. The receiver unit 120 typically comprises receiving circuitry, such as a receiving solenoid 150, and an output 160, such as an audio amplifier and speaker or earphones for outputting some indication of proximity.

The user then receives (630) at the receiving solenoid 150 of the receiver unit 120, the continuous electromagnetic waveform output by the transmitter unit 110, and generates (640) some indication of proximity based at least partially on the strength of the magnetic field generated by the transmitter unit 110, in the form of the continuous electromagnetic waveform. The indication of proximity is then output (650) to a user by way of the output 160 of the receiver unit 120.

Typically, the output (650) of the indication of proximity would be by way of the audio amplifier and speaker or earphones such that the user can listen to the indication. This may be by directly converting the received continuous electromagnetic waveform to a voltage at the receiving solenoid 150 and converting it directly to audio by way of a pre-amp 200 and/or an audio amplifier at the output 160. This direct conversion would be by amplification proportional to the magnetic field at the receiving solenoid 150, and would thereby increase in intensity, and therefore volume when that field strength increased and decrease in volume when the field strength decreases.

Accordingly, some characteristic of the indication of proximity, in this case audible volume, would be based at least partially on the magnetic field strength at the receiving solenoid. The user would then move (660) the receiver unit 120 along the wall while the receiver unit continuously generates and outputs (640, 650) the indication of proximity to the user.

The user would then continue to move (660) the receiver unit 120 until a local maximum is found (670) for the characteristic of the indication of proximity, in this case volume. Such a local maximum would indicate the location of the transmitter unit 110 opposite the wall 190.

In some embodiments, a DC magnetic field is generated, such as by a permanent magnet or simulated permanent magnet. In such embodiments, the indication of proximity may be based partially on a polarity of the magnetic field at the location of the receiving circuitry. In such an embodiment, a user may then determine that the receiver unit 120 has crossed a wall location opposite the transmitter unit 110 when the indication of proximity indicates a reversal of polarity. In some embodiments, the DC magnetic field may be combined with a magnetic field generated by an oscillating signal, as discussed above. In such an embodiment, the user may attempt to find the local maximum as discussed above (at 670), and a more precise determination of location may be possible where a sudden reversal of polarity is detected.

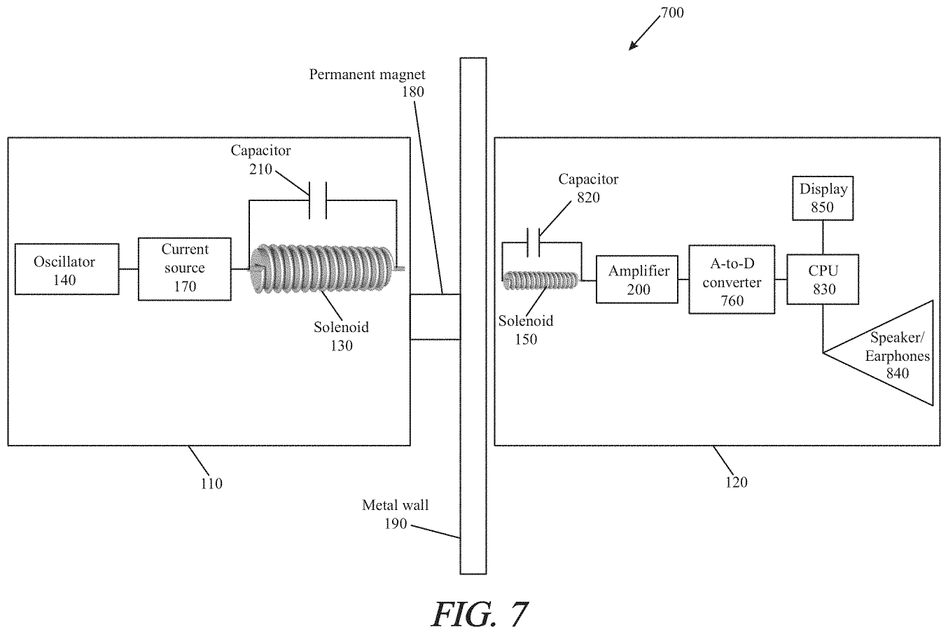

FIG. 7 shows a second embodiment of a system 700 in accordance with this disclosure. The system 700 shown shares many components with the system 100 discussed above with respect to FIG. 1. Therefore, the system 700 generally provides a transmitter unit 710 and a receiver unit 720.

The transmitter unit 710 transmits a continuous waveform as a magnetic field by way of a transmitting solenoid 730, typically paired with a resonance capacitor 810. The transmitter unit 710 may further comprise a harmonic oscillator 740 for generating the continuous waveform and providing it to the transmitting solenoid 730 for transmission by way of a current source or amplifier 770.

The receiver unit 720 may then have receiving circuitry, such as a receiving solenoid 750 paired with a resonating capacitor 820 to receiving the continuous waveform. The receiving solenoid 750 then converts the continuous waveform, received in the form of a magnetic field, into a voltage and provides it to an amplifier 800, such as a pre-amp, which amplifies the voltage from the receiving solenoid 750 in proportion to the strength of the magnetic field.

In the embodiment shown, the output 160 of the system 100 discussed in reference to FIG. 1 is replaced by a digital output comprising an analog to digital converter 760 which feeds the converted signal to processing circuitry 830. The converted signal continues to be proportional to the magnetic field strength at the receiving solenoid 750 and is then may be output as audio at speakers or earphones 840, or may be further processed to display a metric to a user at a digital display 850.

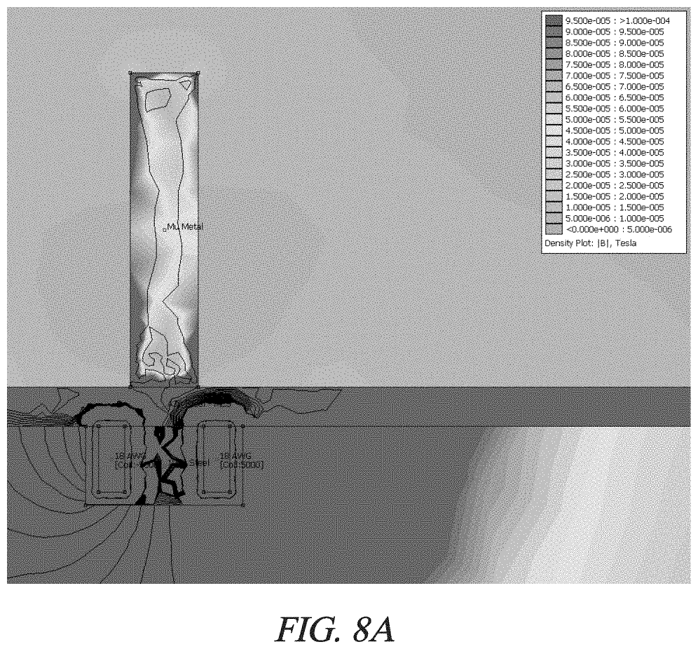

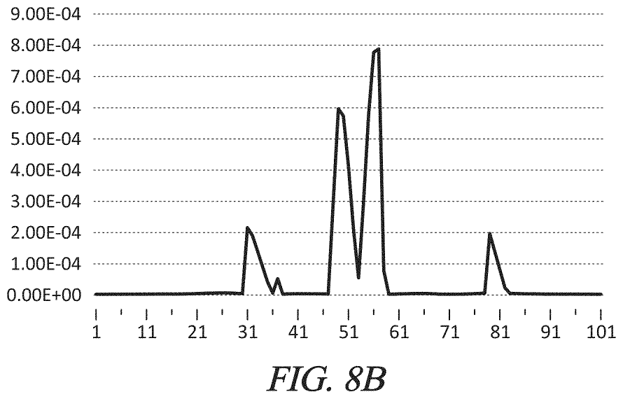

FIG. 8A shows an additional embodiment of a coupling of a transmitter unit 850 and a receiver unit 860 with an intervening wall 190 attenuating flux. FIG. 8B is a profile of magnetic field strength in a lateral direction away from the axis of the transmitter unit 850 of FIG. 8A.

As discussed above in the context of FIG. 3B, when a ferrous metal wall 190 is present, that wall acts as a magnetic shield, concentrating magnet lines of flux within it. This effect reduces the magnetic field detectable on the opposite side of the wall 190.

As noted above, in some applications of welding or cutting into a closed metal surface—such as marine bulkhead—where the operator cannot see the opposite side to know in real time when cutting or welding poses a hazard, even with a “fire watch” individual posted on the opposite, accuracy of less than 0.5 inches is required in marking either “safe” zones or “unsafe zones” for avoiding hazards.

Such accuracy cannot be achieved by all combinations of transmit and receive solenoids on opposite sides of the closed metal surface, because the ferrous metal plate separating to compartments, owing to much lower magnetic reluctance in the ferrous material than the surrounding air, effectively shunts most of the magnetic field emanating from the transmit solenoid, preventing a sharp peak in the magnetic field strength—needed for precise locating on the opposite side of the ferrous barrier.

Moreover, as the ferrous metal barrier gets thicker, the attenuation of the magnetic field radiating from the transmitter increases, further decreasing the accuracy of locating that can be achieved. In addition, it is often necessary, in marine vessel repair for instance, to perform locating of “safe” and “unsafe” areas in order to accurately to cut through up to 2″ of insulation attached to the ferrous surface, further weakening the magnetic field that may be sensed by the receiving solenoid.

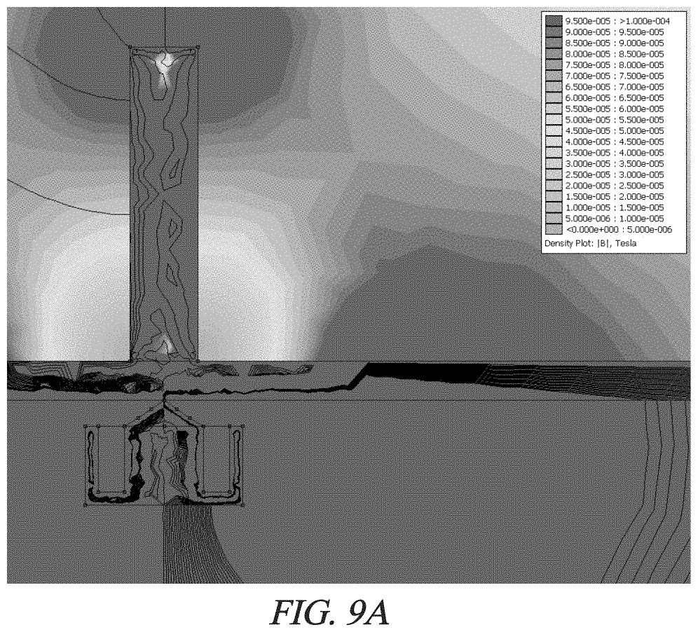

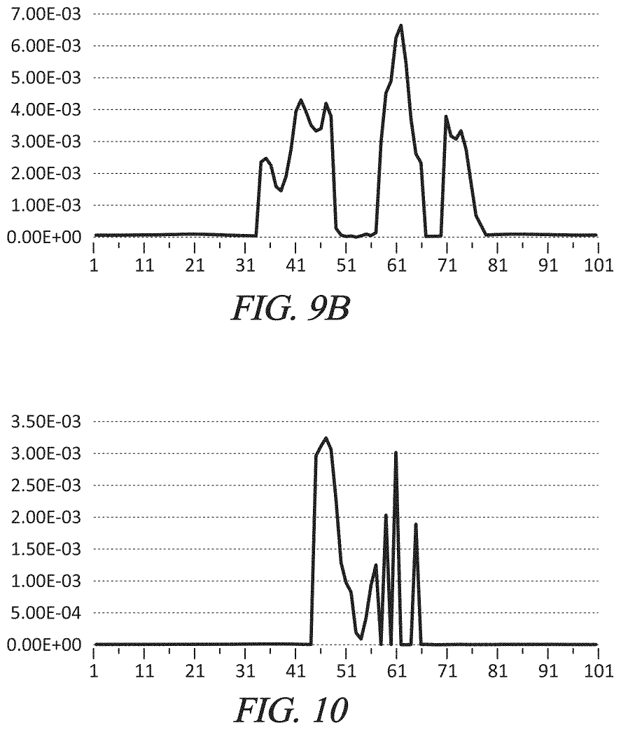

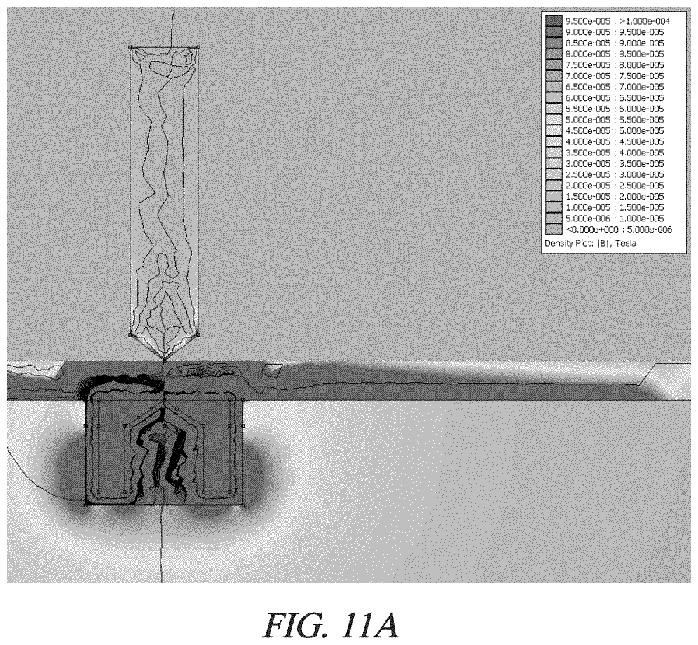

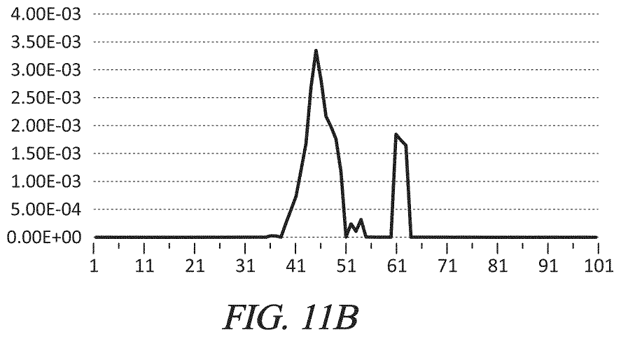

In FIG. 8A, a Finite Element Model (FEM) of magnetic field propagation through a low carbon steel barrier, shows that a steel wall 190 effectively channels the vast majority of a magnetic field i to a “magnetic current” through the wall, leaving a much-weakened field on the opposite side of the wall. In this figure, and in subsequent FIGS. 9A and 11A, an AC magnetic field, oscillating at 5 HZ is used, as discussed above. The magnetic field for these and similar embodiments may be formed by an electromagnetic signal transmitted as a continuous waveform, and may take any of the waveform shapes discussed above. For example, the continuous waveform may be a square waveform at an ultra-low or lower frequency, such as below 10 Hz. Note that the receiving solenoid is able to “pull” some of the magnetic field into its core, owing to lower reluctance of a mu metal core of the solenoid relative to the surrounding air.

FIG. 8B is a profile of magnetic field strength in a lateral direction away from the axis of the transmitter unit on the opposite side of a ferrous barrier, where the transmitter unit has a solenoid with a cylindrical core. The x axis represents distance laterally along the surface of a low carbon steel plate, while the y axis is magnetic flux density in Gauss. The slope of the fall-off of magnetic field strength from the transmit solenoid on the opposite side of a ferrous barrier, which determines the resolution of differentiating field strength versus distance that can be discerned, is flattened considerably by the ferrous barrier, and, as shown in the figures, and this slope flattens dramatically and rapidly with increasing distance perpendicular to the ferrous surface.

One goal of the present disclosure is to increase the slope of the fall-off of the magnetic field strength from the transmit solenoid on the opposite side of the ferrous barrier where it is desired to locate the axis of the transmit solenoid with increased accuracy, such as an accuracy of 0.5″. A further goal of the present invention is to increase the distance between the transmit and receive solenoids over which such accurate positional assessments can be made.

In some embodiments, a system for through-wall locating is therefore provided comprising a transmitter unit 850 for transmitting a magnetic or electromagnetic signal and a receiver unit 860 for detecting a location of the transmitter unit through the wall 190.

The transmitter unit 850 is similar to the transmitter unit 110 discussed above with respect to FIG. 1 and may include, in some embodiments, a transmitting solenoid 130. As discussed below, in some embodiments, the transmitter unit 850 may have a permanent magnet (not shown) in addition to or in place of the transmitting solenoid 130. Where the transmitter unit 110 comprises a transmitting solenoid, the solenoid may then be paired with transmitting circuitry, such as a harmonic oscillator 140 for generating an electromagnetic signal to be transmitter. Alternatively, the transmitter unit 110 include a permanent magnet or electromagnet, and the signal transmitter may be magnetic flux generated by the magnet.

The receiver unit 860 is similar to the receiver unit 120 discussed above with respect to FIG. 1, and may therefore include receiving circuitry, typically including a receiving solenoid 150, for receiving the magnetic or electromagnetic signal. The receiver unit 860 further comprises an output 160 for outputting an indication of proximity between the transmitter unit 850 and receiver unit 860.

A characteristic of the indication of the proximity depends on a strength of a magnetic field generated by the transmitter unit 110 at a location of the receiving circuitry, such as the solenoid 150. The receiver unit 860 and the transmitter unit 850 are then located on opposite sides of the wall 190 through which the location of the transmitter unit is detected.

In some embodiments, methods and structure modifications are used to increase accuracy and axial distance between transmit and receive solenoids over which accurate location assessments can be made is to strongly concentrate the magnetic fields emanating from, and received by the transmitter unit 850 and receiver unit 860 respectively.

FIG. 9A shows an additional embodiment of a coupling of a transmitter unit 900 and a receiver unit 910 with an intervening wall 190 attenuating flux. FIG. 9B is a profile of magnetic field strength in a lateral direction away from the axis of the transmitter unit 900 of FIG. 9A. The transmitter unit 900 and the receiver unit 910 may have internal components similar to those discussed above with respect to the corresponding units of FIGS. 1 and 8A.

As discussed above, the transmitter unit 900 may include a transmitting solenoid 130 for transmitting an electromagnetic signal. Such an electromagnetic signal may be a continuous waveform. The transmitting solenoid 130 may have a cylindrical high permeability core, which may be formed out of, for example, a Mu metal, pure elemental iron, or ferrite ceramic. As shown in FIG. 9A, such a core may be tapered to a point 920, where the point is positioned at the spot 930 that is desired to be precisely located on the transmit side of the wall 190 or other barrier.

Such tapering 920 effectively concentrates the magnetic field generated in the transmitter unit 900 solenoid 130 core into a smaller area than would be possible without tapering. Note that, a significantly greater amount of flux couples into the receiving solenoid 150 when the transmit solenoid 130 is tapered than untampered, as shown in the untampered example of FIG. 8A. FIG. 9B shows the profile of magnetic field strength laterally away from the tapered point location at different distances perpendicular to the barrier. The profile of the magnetic field strength in the example of FIG. 9A shows a peak of 6.5×10\hat{ }−3. Comparing the slopes of these profiles with those in FIG. 8B, which shows a peak of 8×10 \hat{ }−4, it is apparent that tapering increases the slope of the fall-off of magnetic field strength as compared with a simple cylindrical core solenoid, and therefore the accuracy of locating the axis of the transmit solenoid that can be achieved, and the axial distance between transmit and receive solenoids that can be achieved.

Such accuracy can be further increased, and the axial separation of transmit and receive solenoids over which accurate locations can be made, by also tapering the cylindrical core of the receiving solenoid 150, and the results of such a change are shown in FIG. 10.

FIG. 10 is a comparison of slope of fall-off of magnetic field strength with different lateral displacements being both tapered and untapered. As can be seen in the figure, which shows the magnetic field strength inside the receive solenoid as a function of lateral displacement from the transmit solenoid axis, the steepest fall-off of magnetic field strength sensed in the receive solenoid is achieved when both transmit and receive solenoids are tapered.

Accordingly, in some embodiments, a core of each of the transmitting solenoid 130 and receiving solenoid 150 may be tapered at an end of the corresponding solenoid adjacent the wall 190.

FIG. 11A shows an additional embodiment of a coupling of a transmitter unit 1100 and a receiver unit 1110 with an intervening wall 190 attenuating flux. FIG. 11B is a profile of magnetic field strength in a lateral direction away from the axis of the transmitter unit of FIG. 11A. As noted above with respect to FIG. 9A, the transmitter unit 1100 and receiver unit 1110 shown may have internal components similar to those discussed above with respect to FIGS. 1 and 8A.

As shown, in addition to tapering the end of the solenoid core of both the transmitting solenoid 130 and the receiving solenoid 150, the solenoid core of the transmitting solenoid in the transmitter unit 1100 may be enclosed by a collar 1120. Such a collar may be formed of a ferrous material encircling the corresponding solenoid core. While the transmitter unit 1100 is shown as comprising the collar 1120, such a collar can similarly be provided for the receiver unit 1110 either in addition to or in place of the collar 1120 shown.

As shown in FIG. 11B, the steepness of the falloff in magnetic field strength, as sensed in the receiver unit 1110 solenoid 150 may be further increased by incorporating such collars 1120.

In the embodiments shown in FIGS. 8A, 9A, and 11A, the indication of proximity may be received and evaluated in much the same way as discussed above with respect to the embodiment of FIG. 1. As such, a volume of a signal received at the receiver unit 120, 860, 910, 1110, may correspond to proximity for locating purposes.

An additional method of improving locating accuracy at different transmit/receive distances is to operate the transmit solenoid in a DC mode, instead of an AC mode, achieving a “permanent” magnet whose polarity remains fixed. When a the receive solenoid is moved laterally from the axis of the transmit solenoid, a strong polarity reversal will be seen only when the receive solenoid passes directly over the axis of the transmit solenoid.

Accordingly, in some embodiments, the transmitter unit 110, 850, 900, 1100 may be provided with a permanent magnet in place of the transmitting solenoid 130. Alternatively, the transmitting solenoid 130 may be operated in DC mode, thereby simulating a permanent magnet.

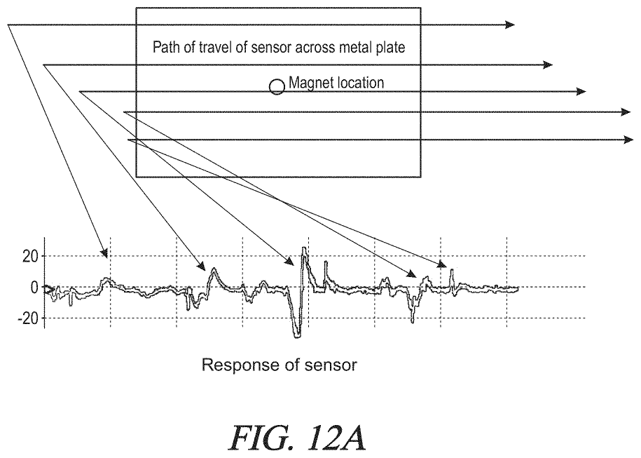

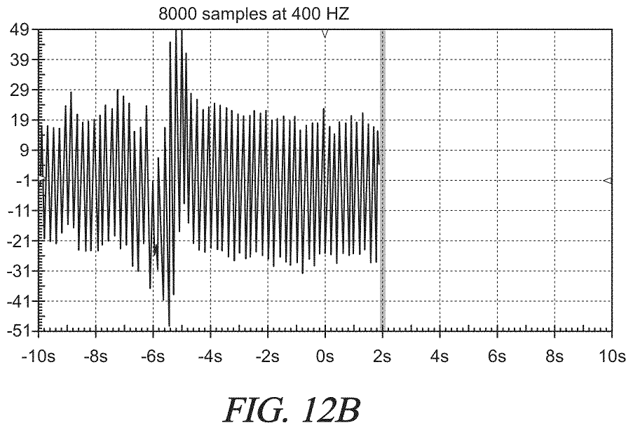

FIG. 12A is an oscilloscope trace of voltages sensed in a receive solenoid moved laterally along a steel surface with a permanent magnet placed opposite a steel plate. As shown, in an embodiment utilizing or simulating a permanent magnet at the transmitter unit 110, 850, 900, 1100, the signal is a magnetic signal comprising a magnetic field generated by the permanent magnet. In such an embodiment, the indication of proximity discussed above includes a reversal of polarity of the magnetic field. Accordingly, this information can be used to determine location by itself to determine proximity.

In some embodiments, a permanent magnet may be used in combination with the transmitting solenoid 130. For example, a permanent magnet 180 used for fixing the transmitter unit 110, 850, 900, 1100 to the wall 190 may contribute to the electromagnetic signal output. The receiving solenoid 150 of the receiver unit 120, 860, 910, 1110 may thereby detect a combined AC and DC signal.

FIG. 12B is an oscilloscope trace of voltages sensed in a receive solenoid moved laterally along a steel surface with a permanent magnet paired with a transmit solenoid placed opposite a steel plate. In such a scenario, the receiving solenoid 150 is exposed to both an oscillating polarity magnetic field and a fixed magnetic field. Note that the envelope of the AC signal modulates with a relative polarity reversal at the point of sensor movement across the metal plate where the combination AC/DC magnet has been placed on the opposite side of the plate. In this scenario, the peak-to-peak amplitude of the AC signal, taken together with the peak-to-peak amplitude of the modulated envelope and envelope polarity reversal, can be taken as the point at which the transmitter unit 110, 850, 900, 1100 has been attached.

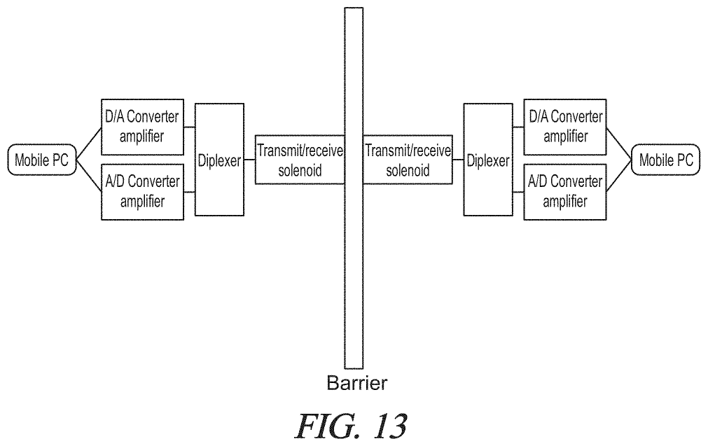

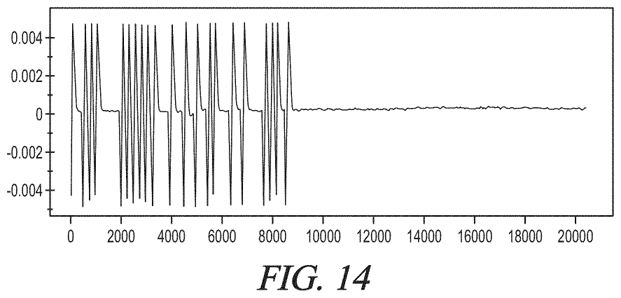

FIG. 13 shows an additional embodiment of a system 1300 in accordance with this disclosure. FIG. 14 shows a response to a transmission in the context of the system 1300 of FIG. 13.

Achieving accurate, and safe “hot work” (welding, cutting, grinding) on ferrous metal surfaces requires good communication between operators on both sides of a barrier.

Owing to the Faraday shield properties of spaces enclosed by metal walls, RF communication between operators on opposite sides of a metal barrier is often unfeasible, requiring operators to tap simple codes back and forth (such as one tap for START and two taps for STOP). Such hampered, meager communications is problematic during both the initial spotting of the proper location to be welded/cut around and during the performance of hot work itself.

In marine ship repair applications for instance, a ship-fitter will work with an assistant to measure and mark corresponding points on opposite sides of a metal bulkhead, where the ship-fitter's assistant will tap on the designated spot (or spots) so that a ship-fitter on the opposite side of the bulkhead can ascertain whether the mark is accurate based upon perceived amplitude of the tap sound. Because back and forth communication between the ship-fitter and assistant is, with simple tapping, very sparse, and tapping is an imprecise method of locating, this method of coordination between operators on opposite sides of a metal wall can be prone to errors.

During actual hot work, a welder on one side of the metal wall will coordinate with a “Firewatch” on the opposite side of the wall to ensure that the wall is not heated in hazardous areas or that slag from the hot work does not spray onto hazardous areas. In such applications, it would be desirable for the Firewatch to communicate precise information (e.g., “move a half inch left”). But again, such precise communication is often infeasible when voices cannot be heard through the wall (or with lots ambient construction noise) and when only simple GO/NO-GO taps are used for communication.

The system 1300 provided uses the same type of transmit and receive solenoids 130, 150 employed in the transmitter unit 110, 850, 900, 1100 and receiver unit 120, 860, 910, 1110, discussed above for precise spot locating to provide rich communication between operates on opposite sides of a metal barrier 190. Such a system 1300 may comprise a transmitter unit 1310 and a receiver unit 1320 which may, in some embodiments, be interchangeable, and can therefore be used to either transmit or receive messages.

Such a transmitter unit 1310 may then comprise a solenoid 130 for transmitting messages as well as message generation circuitry 1330 for generating a message for transmission and transmitting by way of the solenoid 130. Similarly, the receiver unit 1320 may comprise a solenoid 150 for receiving messages, as well as output circuitry and an output 1340 for outputting a communication received at the solenoid 150.

The transmitter unit 1310 may utilize a mobile PC, for example, as the message generation circuitry 1330 and a digital to analog converter and amplifier 1350 may then be used to provide the message to the solenoid 130. Similarly, the receiver unit 1320 may utilize an analog to digital converter and amplifier 1360 to retrieve and interpret a message received at the solenoid 150, and the digital signal may then be interpreted at a corresponding mobile PC to be used as the output circuitry and output 1340.

As noted above, the transmitter unit 1310 and receiver unit 1320 may be interchangeable, and as such, a diplexer 1370 may be used in each to switch between functions. Further, the transmission circuitry discussed may comprise multiple components including the solenoid 130, the digital to analog converter and amplifier 1350, and, in some cases, the message generation circuitry 1330. Similarly, the receiving circuitry may comprise multiple components including the solenoid 150, the analog to digital converter and amplifier 1360, and, in some cases, the output circuitry and output 1340.

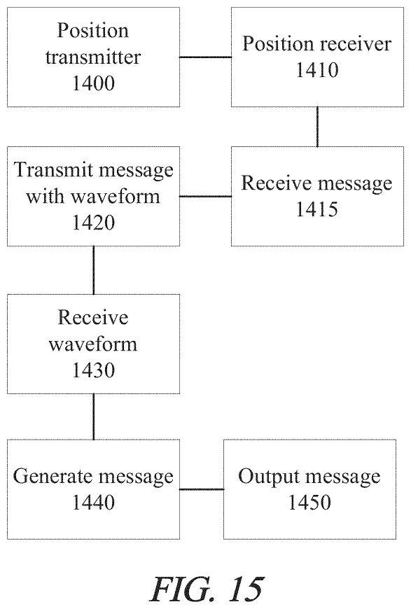

FIG. 15 illustrates a method for utilizing the system 1300 described.

In communicating through a wall, such a system may be utilized by first positioning (1400) a transmitter unit 1310 adjacent a desired location a first side of the wall 190 and positioning (1410) a receiver unit 1320 for receiving communications through the wall adjacent the wall and on an opposite side of the wall from the transmitter unit. The receiver unit 1320 has receiving circuitry, such as a solenoid coil 150, and an output 1340 for outputting a communication received form the transmitter unit 1310.

A message is then transmitted (1420) as an electromagnetic waveform from the transmitter unit 1310 and received (1430) at the receiving circuitry 150 of the receiver unit 1320.

The receiver unit 1320 then generates (1440), by way of the receiver circuitry 150, a message based on the electromagnetic waveform received, and outputs the message (1450) at the output 1340 of the receiver unit. Such an output may be, for example, a text display.

Typically, the message transmitted (1420) is first received by the transmitter unit (1415) at transmission circuitry, as discussed above, which receives the message for transmission and encodes the message into the electromagnetic waveform to be transmitted by the solenoid 130 prior to output. In some embodiments, the encoding of the message into the electromagnetic waveform is by modulating a continuous waveform or pulsing a discontinuous waveform.

In some embodiments, the message is received at the transmission circuitry as text, and the message generated at the receiving circuitry is a text based message extracted from the electromagnetic waveform.

As discussed above with respect to the locating systems, the method may involve utilizing an ultra-low frequency, such as a frequency lower than 10 Hz.

Accordingly, a two-way text communication system may be provided using transmit and receive solenoids 130, 150 as communication transducers. Text entered by one operator on a mobile PC or processor 1330 via touch screen or key pad is encoded into a data stream in the PC, then sent to a D/A converter and amplifier 1350 to modulate emissions from the transmit coil. Multiple schemes for modulating and encoding and demodulating and decoding text data are contemplated, such as digital 1's and 0's being encoded by pulse length, and text letters then further encoded as 8 bit ASCI character strings comprised of 1's and 0's modulated from pulse length, or other modulation scheme.

On the receive side of the barrier 190, the receive solenoid 150 senses changes in magnetic field strength, and these signals are sent to an A/D converter and amplifier 1360 feeding a mobile PC 1340, which then demodulates the encoded 1's and 0's, and decodes the ASCI text, displaying the text on the screen.

A diplexer 1370, controlled by the Mobile PC 1330, 1340, switches the solenoids 130, 150 back and forth as needed from transmit to receive mode, allowing two-way communication.

FIG. 14 shows responses in a sensor to encoded text (encoded in Morse code) received by the receive sensor and demodulated and decoded to transmit text through the metal barrier 190 from a transmitting solenoid 130 to a receiving solenoid 150.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudo-code, and the like represent various processes which may be substantially represented in computer readable media and so executed by a computer or processor, whether or not such computer or processor is explicitly shown.

The embodiments of the present disclosure disclosed herein may comprise a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device may receive computer readable program instructions from the network and forward the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++, Java, Perl, Python or the like, and conventional procedural programming languages, such as the “C” programming language or similar programming languages. The computer readable program instructions may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

A processor or processor circuitry may include a device that has any combination of hardware, circuitry, and software. The hardware and circuitry examples may comprise a parallel processor, a processor array, a vector processor, a scalar processor, a multi-processor, a microprocessor, a communication processor, a network processor, a logic circuit, a queue management device, a central processing unit (CPU), a microprocessing unit (VIPU), system on a chip (SoC), a digital signal processor (DSP), an integrated circuit (IC), an application specific integrated circuit (ASIC), a programmable logic device (PLD), and a field programmable gate array (FPGA). A processor or processor circuitry may include one or more processors, one or more circuits and/or software, that responds to and processes basic computer instructions and carries out the instructions of a computer program by performing the basic arithmetic, logical, control and input/output (I/O) operations specified by the instructions, one or more of: an arithmetic logic unit (ALU), which may carry out arithmetic and logic operations on the operands in instructions; a floating point unit (FPU), also known as a math coprocessor or numeric coprocessor, which is a specialized coprocessor that may manipulate numbers more quickly than the basic microprocessor circuitry can in some cases; one or more registers, which may hold instructions and other data and supply operands to the ALU and store the results of operations; and cache memory, which may save time compared to having to get data from random access memory (RAM). A processor or processor circuitry may also include one or more circuits comprising electronic components, such as resistors, memristors, power sources, magnetic devices, motors, generators, solenoids, microphones, speakers, transistors, capacitors, inductors, diodes, semiconductors, switches, antennas, transducers, sensors, detectors, vacuums, tubes, amplifiers, radio receivers, crystals, and oscillators connected by conductive wires or traces through which electric current can flow. The combination of components and wires may allow various simple and complex operations to be performed: signals may be amplified, computations can be performed, and data can be moved from one place to another.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A system for through-wall locating comprising:
a transmitter unit for transmitting a magnetic or electromagnetic signal;
a receiver unit for detecting a location of the transmitter unit through a wall, the receiver unit comprising:
receiving circuitry for receiving the magnetic or electromagnetic signal; and
an output for outputting an indication of a proximity between the transmitter unit and receiver unit, wherein a characteristic of the indication of the proximity depends on a strength of a magnetic field generated by the transmitter unit at a location of the receiving circuitry,
wherein the receiver unit and the transmitter unit are located on opposite sides of the wall through which the location of the transmitter unit is detected.

2. The system of claim 1, wherein the magnetic or electromagnetic signal is a continuous waveform, and wherein the transmitter unit comprises a transmitting solenoid for transmitting the continuous waveform, and wherein the receiving circuitry comprises a receiving solenoid for receiving the continuous waveform from the transmitting solenoid, and wherein a core of at least one of the transmitting solenoid and the receiving solenoid is tapered at an end of the corresponding solenoid adjacent the wall.

3. The system of claim 2, wherein a core of each of the transmitting solenoid and the receiving solenoid is tapered at an end of the corresponding solenoid adjacent the wall.

4. The system of claim 2, wherein the tapered core is the core of the receiving solenoid and the receiver unit further comprises a collar encircling the receiving solenoid, the collar formed of a ferrous material.

5. The system of claim 2, wherein the tapered core is the core of the transmitting solenoid and the transmitter unit further comprises a collar encircling the transmitting solenoid, the collar formed of a ferrous material.

6. The system of claim 2, the receiver unit further comprises an amplifier for amplifying the received continuous waveform from the receiving solenoid in proportion with an intensity of the waveform received at the receiving solenoid.

7. The system of claim 2, wherein both the transmitting solenoid and the receiving solenoid are oriented perpendicular to the wall through which the transmitter unit is being detected by the receiver unit, and wherein the receiving solenoid is selected to be in resonance with the transmitting solenoid at the frequency of the continuous waveform.

8. The system of claim 7, wherein the strength of the magnetic field generated by the transmitter unit at the location of the receiving circuitry is increased by resonant inductive coupling when the transmitting solenoid and the receiving solenoid are substantially axially aligned.

9. The system of claim 2, wherein the transmitter unit further comprises an oscillator for generating the continuous waveform, where the continuous waveform is an ultra-low frequency or lower frequency waveform.

10. The system of claim 9, wherein the continuous waveform is a square waveform at a frequency below 10 Hz.

11. The system of claim 9, wherein the continuous waveform is a sawtooth or sinusoidal waveform.

12. The system of claim 2, wherein the output is an audio amplifier for amplifying the continuous waveform proportionally to the magnetic field strength at the receiving circuitry and outputting the amplified continuous waveform as audio, wherein the characteristic of the indication of the proximity is a volume, frequency, sharpness, or pitch of the audio.

13. The system of claim 2, the transmitter unit further comprising a permanent magnet for fixing the transmitter unit to a wall through which the system is being used to locate, and wherein the permanent magnet contributes to the electromagnetic signal output, such that the receiving solenoid detects a combined AC and DC signal.

14. The system of claim 1, wherein the transmitter unit further comprises a permanent magnet, and wherein the magnetic or electromagnetic signal is a magnetic field generated by the permanent magnet, and wherein the indication of the proximity includes a reversal of polarity of the magnetic field.

15. A method for through-wall locating, the method comprising:
positioning a transmitter unit adjacent a desired location on a first side of a wall, the transmitter unit comprising a permanent magnet;
transmitting a magnetic field from the transmitter unit;
positioning a receiver unit for detecting a location of the transmitter unit through the wall adjacent the wall and on an opposite side of the wall from the transmitter unit, the receiver unit comprising receiving circuitry and an output for outputting an indication of proximity between the transmitter unit and the receiver unit;
detecting, at the receiving circuitry of the receiver unit, the magnetic field output by the transmitter unit;
generating the indication of proximity based at least partially on a polarity of a magnetic field generated by the transmitter unit at a location of the receiving circuitry;
moving the receiver unit along the wall while observing the indication of proximity;
determining that the receiver unit has crossed a wall location opposite the transmitter unit when the indication of proximity indicates a reversal of polarity.

16. A method for through-wall communications, the method comprising:
positioning a transmitter unit for transmitting communications adjacent a desired location on a first side of a wall;
positioning a receiver unit for receiving communications through the wall adjacent the wall and on an opposite side of the wall from the transmitter unit, the receiver unit comprising receiving circuitry and an output for outputting a communication received from the transmitter unit;
transmitting an electromagnetic waveform from the transmitter unit;
receiving, at the receiving circuitry of the receiver unit, the electromagnetic waveform output by the transmitter unit;
generating, at the receiving circuitry of the receiver unit, a message based on the electromagnetic waveform received;
outputting the message at the output of the receiver unit.

17. The method of claim 16, wherein the transmitter unit further comprises transmission circuitry for receiving a message for transmission, and wherein the received message is encoded into the electromagnetic waveform prior to output.

18. The method of claim 17, wherein the encoding of the message into the electromagnetic waveform is by modulating a continuous waveform or pulsing a discontinuous waveform.

19. The method of claim 17, wherein the message is received at the transmission circuitry as text and wherein the message generated at the receiving circuitry is a text based message extracted from the electromagnetic waveform.

20. The method of claim 16, wherein the electromagnetic waveform has a frequency lower than 10 Hz.
